(19) United States
(12) Patent Application Publication
(10) Pub. No.: US 2023/0022821 A1
(43) Pub. Date: Jan. 26, 2023

(54) Versatile Decor Device

(71) Applicant: Stacey Doss, Marietta, GA (US)

(72) Inventor: Stacey Doss, Marietta, GA (US)

(21) Appl. No.: 17/709,082

(22) Filed: Mar. 30, 2022

Related U.S. Application Data
(60) Provisional application No. 63/225,135, filed on Jul. 23, 2021.
(60) Provisional application No. 63/225,277, filed on Jul. 23, 2021.

(51) Int. Cl. B32B 7/06; B32B 5/26; B32B 29/02; B32B 7/12

(52) U.S. Cl. CPC B32B 7/06; B32B 5/26; B32B 29/02; B32B 7/12; B32B 2451/00; B32B 2250/03; B32B 2601/00

(57) ABSTRACT

The versatile décor device intents to provide users with a range of possibilities for decorating their furniture pieces in a variety of ways. To accomplish this, the device includes at least one piece of a bonded fabric that includes a top layer and a bottom layer. The bonded fabric includes a plurality of parallel cuts and a plurality of singular cuts that enable different ornamental objects to be attached to the furniture. The bottom layer of the bonded fabric has an adhesive material and protective peel on it for securing the device to a piece of furniture or other surfaces. Further, different varieties of fasteners may be integrated onto the bonded fabric, so as to enable fastening of different décor items to the bonded fabric. Additionally, the bonded fabric may be made into larger shapes and configurations to cover bigger furniture.

### FIELD OF THE INVENTION

The present invention relates generally to a versatile décor device, more specifically to a decoration system capable of giving the owner more possibilities in furniture decoration. The present invention is a collection of components that one can place over or on a piece of furniture or any other surfaces to one's preference and then attach decorations to said components.

### BACKGROUND OF THE INVENTION

Decorating one's living space is a common way for one to express creativity and personality. Most accomplish this self-expression with stationary wall art or floor rugs. Others may like to decorate pieces of furniture but may find decorating furniture limiting in the number of possibilities. Existing possibilities include slipcovers, pillows, and throw blankets. These existing items are typically meant more for practicality than decoration to begin with. Pillows and throw blankets are meant more for comfortability than decorations, and slipcovers can only go so far in the decoration department. The present invention aims to overcome these limitations of furniture decoration.

### SUMMARY

It is an objective of the present invention to provide users with a range of possibilities for decorating their furniture pieces in a variety of ways. The present invention includes at least one piece of a bonded fabric that includes a top layer and a bottom layer. The bonded fabric or the top layer alone may comprise a plurality of cuts that enable different ornamental objects and fasteners to be attached to the furniture. The bottom layer has an adhesive material superimposed on it for securing the at least one piece of fabric to a piece of furniture. A protective peel covers the adhesive material before attaching the bonded fabric to various surfaces. Further, different varieties of fasteners may be integrated onto the bonded piece, so as to enable fastening of the present invention to a wide variety of surfaces and décor items. Additionally, the present invention may comprise at least one decorative label integrated onto it, so that the bonded fabric itself may be used as a decorative item. Furthermore, the present invention may be made into larger shapes and configurations to fit onto and cover bigger pieces of furniture such as couches, sofa sets, chairs, etc. Thus, the present invention is a creative and versatile décor device that is user friendly and cost-effective as well.

### BRIEF DESCRIPTION OF THE DRAWINGS

FIG. 1 is a top-front-left perspective view of the present invention, wherein the bonded fabric is in the shape of a hexagon and the fastener is a string.

FIG. 2 is a bottom-front-left perspective view of the present invention.

FIG. 3 is a front elevational view of the present invention.

FIG. 4 is an exploded view of FIG. 3.

FIG. 5 is a top-front left perspective view of the present invention, wherein two leaf shaped bonded fabrics have two associated pieces of a single fastener being mounted onto them.

FIG. 6 is a bottom-rear-right perspective view of the present invention in FIG. 5.

FIG. 7 is a side elevational view of the invention in FIG. 5.

FIG. 8 is a top front perspective view of the present invention, wherein the bonded fabric is rectangular.

FIG. 9 is a rear elevational view of the present invention shown in FIG. 8.

FIG. 10 is a top-front-left perspective view of the present invention with a decorative label integrated onto the bonded fabric.

FIG. 11 is a top plan view of the present invention shown in FIG. 10.

FIG. 12 is a top-front-left perspective view of the present invention, wherein the bonded fabric is in the shape of a furniture cover.

FIG. 13 is a bottom perspective view of the invention in FIG. 12.

FIG. 14 is a front elevational view of the present invention in FIG. 12.

### DETAILED DESCRIPTIONS OF THE INVENTION

All illustrations of the drawings are for the purpose of describing selected versions of the present invention and are not intended to limit the scope of the present invention.

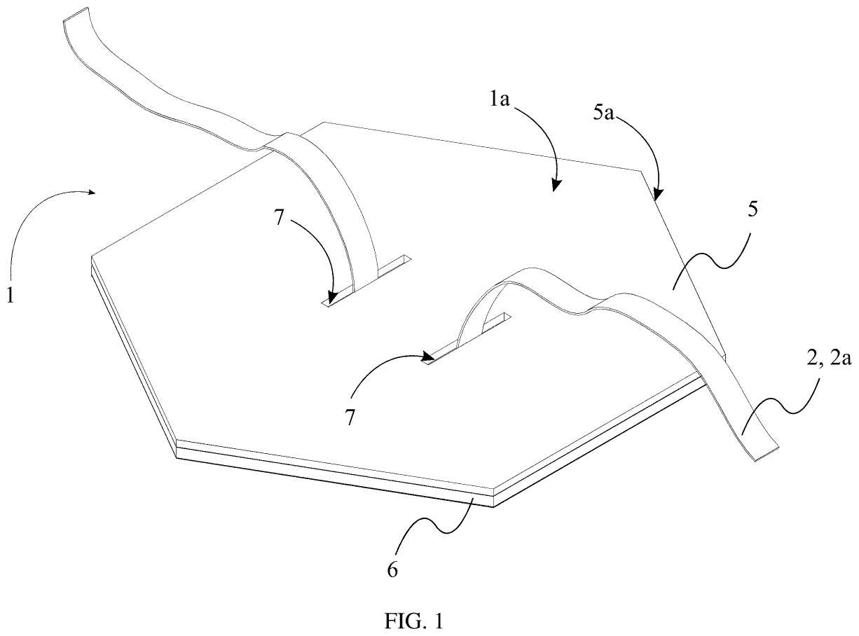

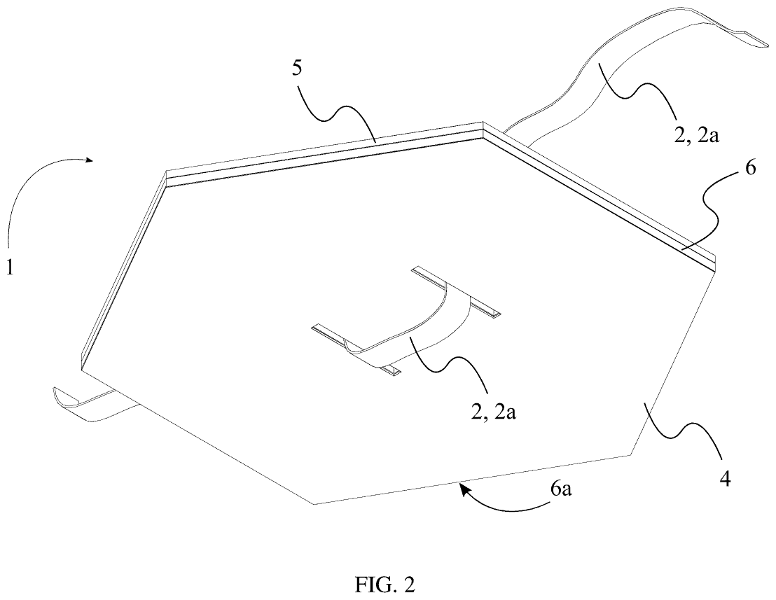

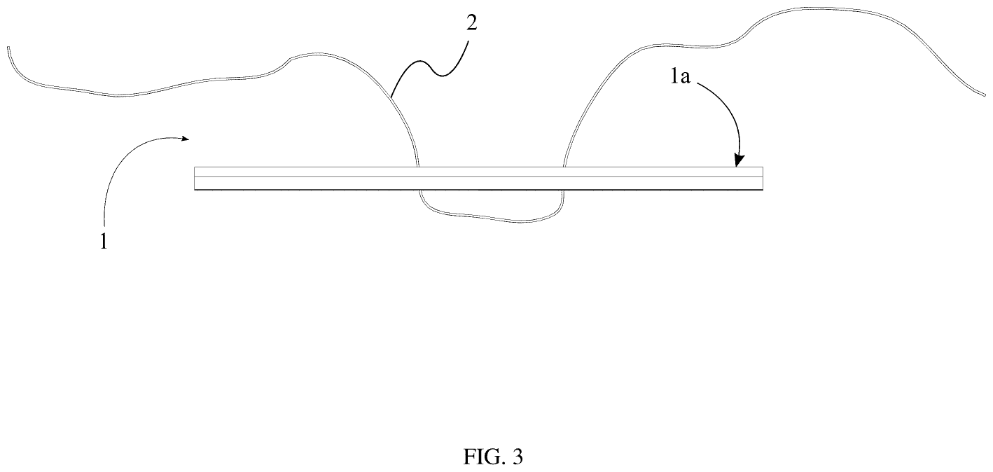

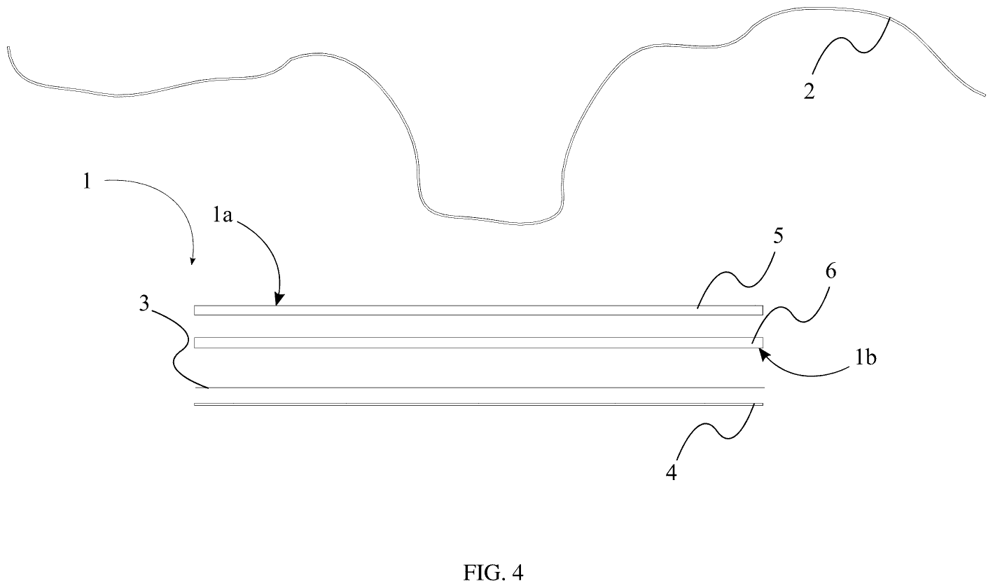

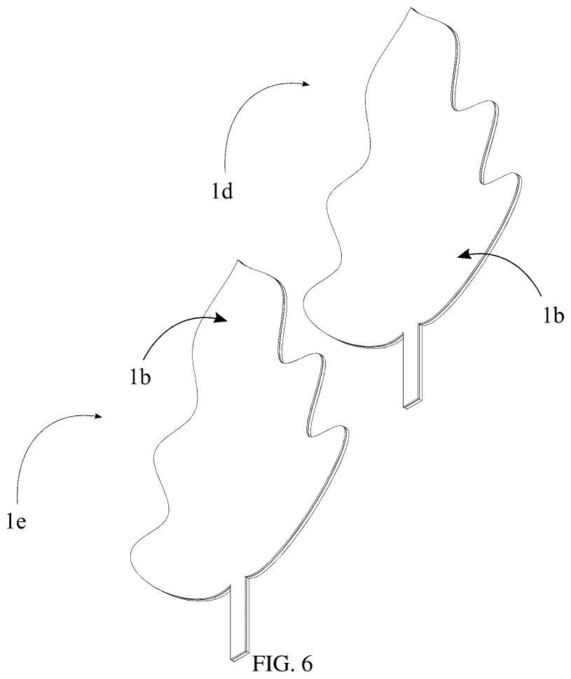

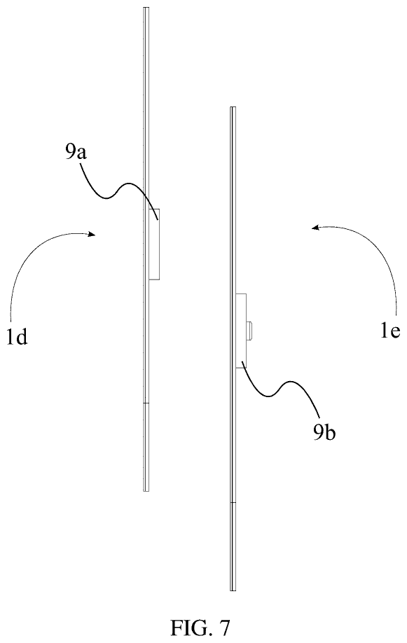

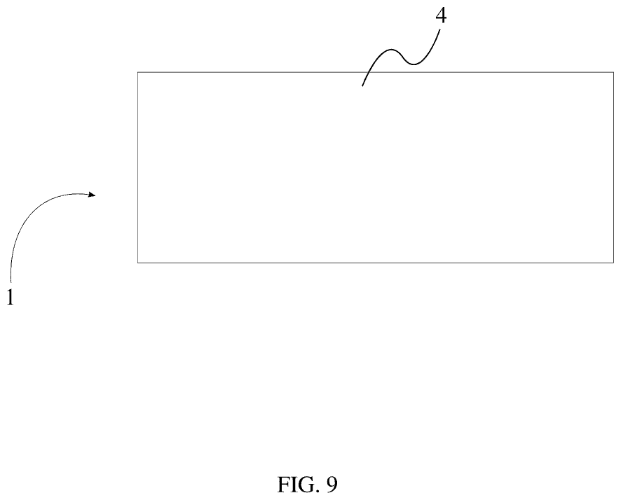

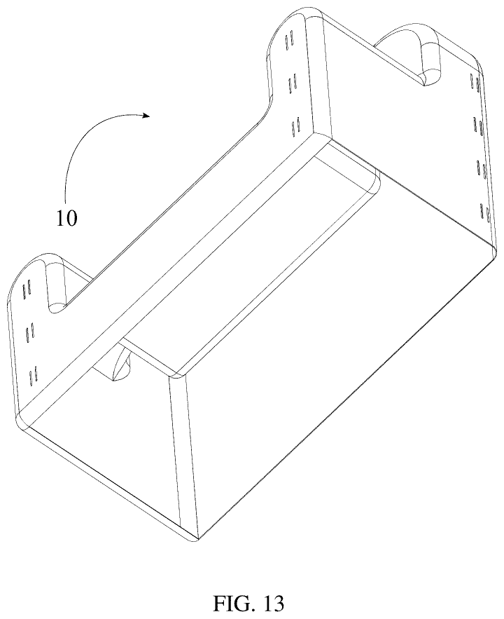

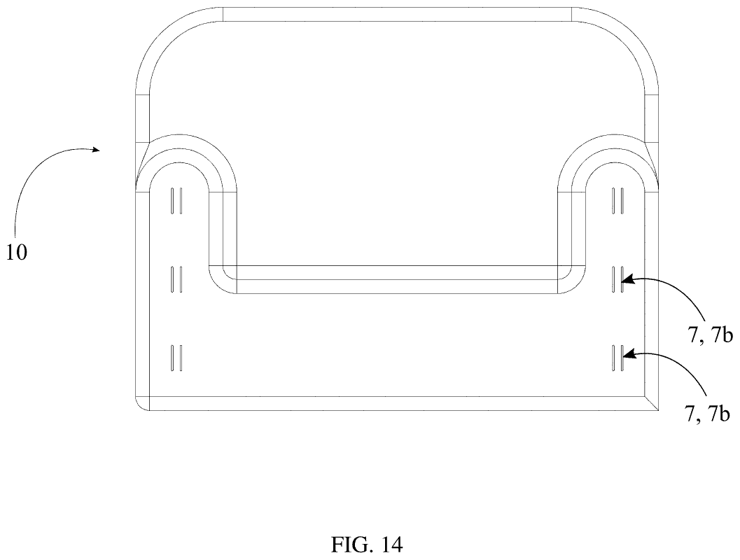

In reference to FIG. 1 through FIG. 14, the present invention is a versatile décor device. It is an objective of the present invention to provide users with a range of possibilities for decorating their furniture pieces in a variety of ways. The present invention includes at least one piece of a bonded fabric that includes a top layer and a bottom layer. The bonded fabric or the top layer alone may comprise a plurality of cuts that enable different ornamental objects and fasteners to be attached to the furniture. The bottom layer has an adhesive material superimposed on it for securing the at least one piece of fabric to a piece of furniture. A protective peel covers the adhesive material before attaching the bonded fabric to various surfaces. Further, different varieties of fasteners may be integrated onto the bonded piece, so as to enable fastening of the present invention to a wide variety of surfaces and décor items. Additionally, the present invention may comprise at least one decorative label integrated onto it, so that the bonded fabric itself may be used as a decorative item. Furthermore, the present invention may be made into larger shapes and configurations to fit onto and cover bigger pieces of furniture such as couches, sofa sets, chairs, etc. Thus, the present invention is a creative and versatile décor device that is user friendly and cost-effective as well.

The following description is in reference to FIG. 1 through FIG. 14. According to a preferred embodiment, the present invention comprises a bonded layer 1, a fastener 2, an adhesive layer 3, and a protective cover 4. Preferably, the bonded layer 1 comprises a first layer 5 and a second layer 6, wherein the first layer 5 is normally attached to the second layer 6. Preferably, the first layer 5 and the second layer 6 are thin layers of fabric that are made of a flexible material. Further, the first layer 5 may be bonded with the second layer 6 by means of a permanent bond fusible web adhesive. However, the first layer 5 may be attached by any other means that are known to one of ordinary skill in the art, as long as the objectives of the present invention are fulfilled. Examples of such methods include, but are not limited to iron-on adhesives, sewing, glue or any other chemical adhesives etc. In alternate embodiments, only terminal edges of the first layer 5 and the second layer 6 may be interconnected. The material, color, and dimensions of the fabric will vary depending on the user's desired uses. Furthermore, a first transversal cross section 5a of the first layer 5 is same as a second transversal cross section 6a of the second layer 6. In other words, the bonded layer 1 is formed by cutting the first layer 5 and the second layer 6 together along a same transversal cross section, after being bonded to each other. As seen in FIG. 1 through FIG. 14, the first layer 5 and the second layer 6 may comprise any size, shape, dimension, material, components, arrangement of components etc. that are known to one of ordinary skill in the art, as long as the intended objectives of the present invention are not altered.

According to the preferred embodiment, the fastener 2 is integrated onto a first surface 1a of the bonded layer 1. The fastener 2 is the connecting component that attaches the present invention to an external décor item or material of choice. Depending on the dimensions, shape and material of the bonded layer 1, as well as based on the surface on which the bonded layer 1 is going to be used as a décor item, a wide variety of fasteners 2 may be used for the present invention, as long as the objectives of the present invention are fulfilled. Examples of such fasteners include, but are not limited to strings, snap buttons, clips, buttons, magnetic fasteners, hook and loop fasteners etc. This is so that, a flower, a picture, a plurality of lights, an ornament etc. may be attached with the fastener 2 of choice onto the bonded layer 1.

In order to attach the bonded layer 1 to a desired surface of choice, the adhesive layer 3 is superimposed onto a second surface 1b of the bonded layer 1, wherein the second surface 1b is positioned opposite to the first surface 1a across the bonded layer 1. More specifically, the second surface 1b is same as the bottom surface of the second layer 6. Preferably, a double-sided adhesive layer is stuck to the back surface of the bonded layer 1. However, the adhesive layer 3 may comprise any form of adhesives that are known to one of ordinary skill in the art, and the adhesive layer 3 may be sprayed on or rolled on to the second surface 1b of the bonded layer 1.

In order to prevent the adhesive layer 3 from sticking onto unwanted surfaces and for providing a clean device, the protective cover 4 is detachably attached to the second surface 1b of the bonded layer 1, wherein the protective cover 4 covers the adhesive layer 3. It is ideal for the protective cover 4 to be placed over the bonded layer 1 prior to putting the fabric in place. Preferably, the protective cover 4 is a paper that peels off, so that the user may attach the bonded layer 1 to a furniture or a desired surface, after peeling off the protective cover 4. However, the protective cover 4 may comprise any other material, technology, shape, size, components, arrangement of components etc. as long as the intents of the present invention are not altered.

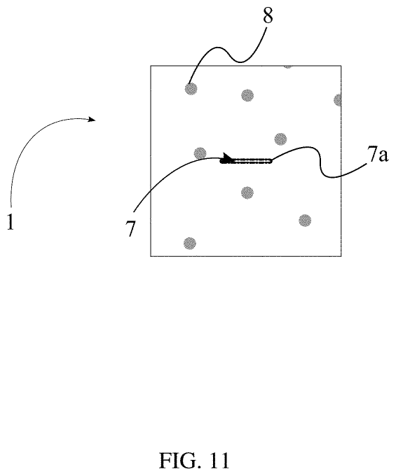

It is an aim of the present invention to attach various décor pieces and items onto the bonded layer with the help of various fasteners. To that end, wherein the fasteners require an aperture to be threaded through, the present invention comprises at least one aperture 7. Preferably, the at least one aperture 7 traverses through the bonded layer 1, and the fastener 2 is integrated through the at least one aperture 7. As seen in FIG. 1 through FIG. 3, the at least one aperture 7 is a rectangular slit. However, the at least one aperture 7 may comprise any other size, shape, location, orientation, dimensions etc. as long as the intents of the present invention are not altered. Further, in order to provide strength and stability to the at least one aperture 7 for holding the fastener, the at least one aperture 7 is reinforced by a reinforcement medium 7a, as seen in FIG. 11. For example, the reinforcement medium 7a may be stitches of thread made around a slit, tapes, additional fabrics sewn around etc. However, any other reinforcement medium 7a may also be used to stabilize and reinforce the at least one aperture. Furthermore, in an alternate embodiment, the at least one aperture 7 may also traverse only through the first layer 5, depending on the purpose and type of the fastener 2 utilized.

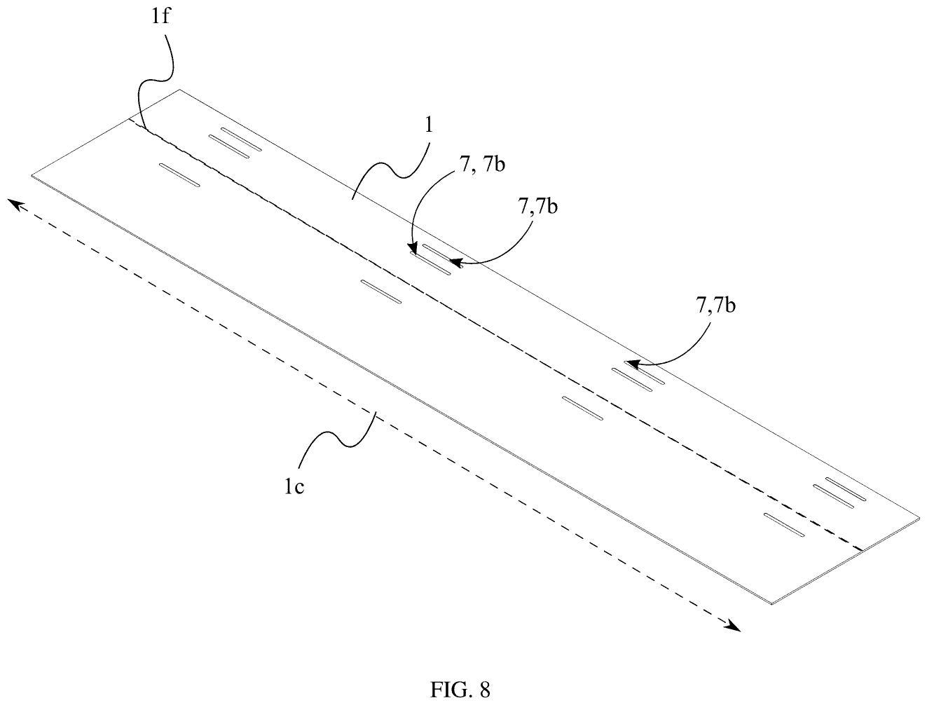

As seen in FIG. 8 and FIG. 12 through FIG. 14, the at least one aperture 7 may be a plurality of pairs of slits 7b, wherein a single pair of slits 7c is positioned parallel to each other, wherein the single pair of slits 7c is from the plurality of pairs of slits 7b. The plurality of parallel slits is two thin, slot shaped cuts parallel to one another in the fabric of the bonded layer 1. In reference to FIG. 8, the plurality of pairs of slits 7b is distributed along a length 1c of the bonded layer 1. Further the bonded layer 1 in FIG. 8 may be a single decor device or may be split along 1f, thereby providing two different décor devices with apertures oriented in different directions. In this case, the entire rectangular bonded layer 1 may be stuck on top of a couch (singularly or split) or attached onto a wall surface such as above a couch, on the mantle etc., wherein decorative items fit for an event, an occasion or a season may be integrated onto the bonded layer with the help of the apertures and fasteners. For example, the decorative items may be balloons, lights, party theme decor, fall themed items, Christmas decorations etc. In other words, the main purpose of the plurality of parallel slots or pair of slits is to allow decorations to be tied to the fabric via string, twine, or any other similar object. The placement of the plurality of pairs of slits 7b are ideally offset to either long edge of the bonded layer 1. Each of the plurality of pairs of slits 7b or singular slots may be in a vertical or horizontal position with respect to the length 1c of the bonded layer 1. The variety of lengths the fabric is provided in, opens a wide range of possible decoration configurations. The preferred embodiment can be provided in lengths for a multitude of furniture pieces and sections of said furniture. The number of slots depends on the length 1c of the fabric. Additionally, as seen in FIG. 1 through FIG. 4, wherein the fastener 2 being a string 2a and the at least one aperture 7 being a single pair of slits 7c, the string is threaded through the pair of slits 7c. Accordingly, open ends of the string 2a protrude through the pair of slits 7c and extend over the first surface of the bonded layer. A decorative item such as a flower, a leaf, an ornament etc. may be tied onto the bonded layer 1 with the help of the string 2, and this bonded layer 1 may be stuck on to a surface of choice with the help of the adhesive layer 3, after peeling off the protective cover 4.

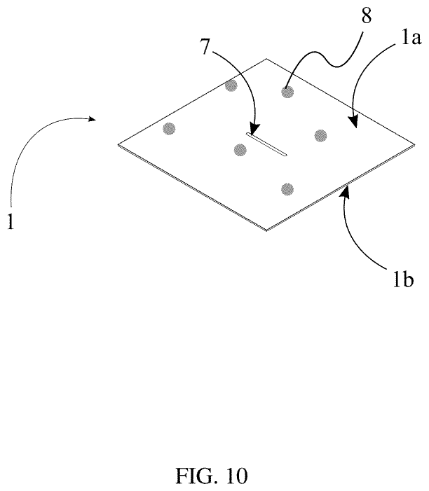

In reference to FIG. 10 and FIG. 11, the at least one aperture 7 is meant for items with buttons sewn to be attached to the fabric. The button sewn into an item can be inserted into any member of the at least one aperture 7 such that a separate piece of bonded fabric with the button may be integrated into the at least one aperture, affixing the item to the fabric. The bottom surface of each fabric configuration consists of a sticky, adhesive glue both permanent and/or temporary to securely attach the fabric to furniture. More specifically and in other words, one fabric piece would have the attached button and the other fabric piece would have a slit so the button may be inserted. The slit would either be sewn around edges, glued, or reinforced by any related method so that the threads don't unravel.

It is an aim of the present invention to provide versatility and creativity into the device. To accomplish this, the present invention comprises a decorative label 8, wherein the decorative label 8 is mounted onto the bonded layer 1. The decorative label 8 may be any accessory or creative addition to the bonded layer 1, that can help in the decorative process. Examples of such decorative labels 8 include, but are not limited to wiggle eyes, contrasting color and fabric pieces etc. For example, wiggly eyes may be stuck onto a bonded layer 1 cut in the shape of an animal, velvet ears and cotton balls may be added to a bunny for easter décor, glitter may be added to a party decoration etc. In reference to FIG. 10, the decorative label 8 is a fabric with a polka dot pattern. However, the decorative label 8 may include any other shape, size, design, components, arrangement of components etc. that are known to one of ordinary skill in the art, as long as the intents of the present invention are not hindered. Thus, the decorative label 8 enables both kids and adults to be able design their décor of choice and thus be creative with the present invention.

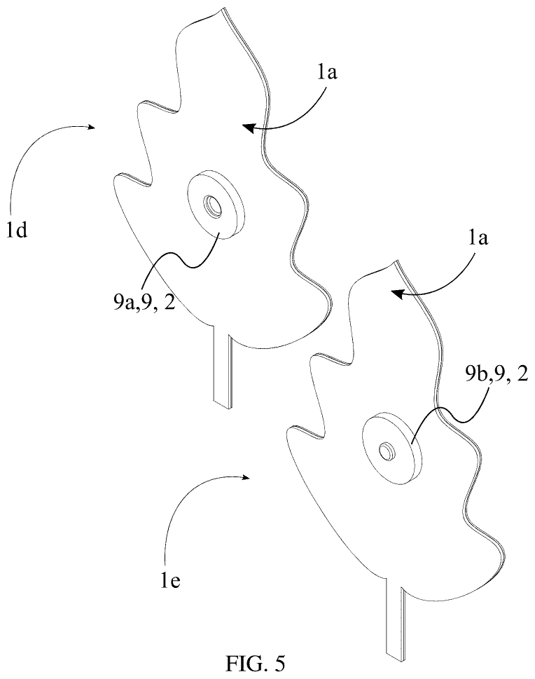

In reference to FIG. 5 through FIG. 7, two parts of a single fastener 2 are integrated onto two separate bonded layers 1 to create a decorative item. To that end, a first part 9a of a first fastener 9 is integrated onto a first bonded layer 1d, and a second part 9b of the first fastener 9 is integrated onto a second bonded layer 1e. As seen in FIG. 5 through FIG. 7, the first bonded layer 1d and the second bonded layer 1e are cut in the shape of leaves and the first fastener 9 is a snap button. Thus, the first bonded layer 1d may be detachably connected to the second bonded layer 1e, wherein the first part 9a of the first fastener 9 is fastened with the second part 9b of the first fastener 9. In other words, when the two parts of the first fastener 9 or the snap buttons are fastened, the user gets a smooth three-dimensional leaf shaped décor item.

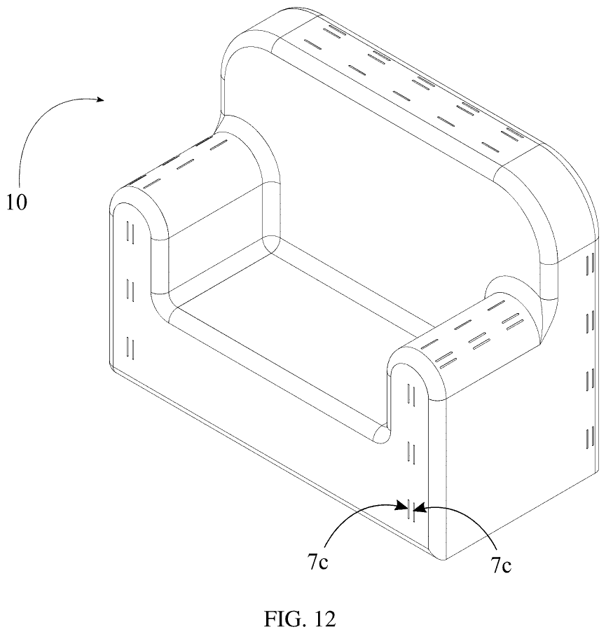

In reference to FIG. 12 through FIG. 14, an alternate embodiment of the present invention is depicted, wherein the bonded layer 1 is a furniture cover 10. The furniture cover 10 is a fabric sewn into the shape of the external surface of a standard couch, wherein the fabric is made of a flexible and stretchable material. The furniture cover 10 may be a single one-piece cover or made in multiple parts such as arm covers, back seat cover, bottom seat cover, etc. The furniture cover 10 does not have a bottom surface so that the furniture cover 10 can be placed over a couch. To function properly as a furniture cover 10, the internal surface of the furniture cover 10 conforms to the specified couch or seat that the furniture cover 10 was purchased for. In additional embodiments, the size and shape of this furniture cover can be specified to fit a variety of furniture styles. In this embodiment, the at least one aperture 7 comprises pluralities of singular and parallel slots disposed along multiple surfaces on the furniture cover 10 such as the front, sides, top, and arms include. The combination of the furniture cover 10 with the pluralities of singular and parallel slots allows one to avoid using the fabric configurations and the adhesive material involved in the fabric pieces. In this embodiment, the first layer 5 and second layer 6 are sewn onto/into the furniture cover 10. Further, the at least one aperture 7 are cut through the top layer, but do not cut through any bottom layer. This is so that, the plurality of parallel slots and the plurality of singular slots allow one to attach a variety of decorations to the furniture that the fabric resides on. However, the at least one aperture 7, may traverse through the bottom layer 6 as well. Alternately, the furniture cover 10 may comprise only the first layer 5 as well. In this embodiment, the second layer 6 may be added, but only bonded and reinforced around the cut slits/slots for added hold/support. In other words, the second layer is attached to at least one specific region of the first layer, wherein the at least one specific region comprises regions around the at least one aperture, the fastener etc. In addition to fasteners like string that can be used to tie decorations to the fabric or furniture cover 10, additional fasteners may be utilized to attach decorations. For example, decorative items like string lights or garland may be attached round the furniture with the help of strings. Further, fasteners 2 like buttons sewn into decorations, among other methods, could be used as an attachment system. Although the invention has been explained in relation to its preferred embodiment, it is to be understood that many other possible modifications and variations can be made without departing from the spirit and scope of the invention as hereinafter claimed.

What is claimed is:

1. A versatile decorative device, comprising:
a bonded layer;
a fastener;
an adhesive layer;
a protective cover;
the bonded layer comprising a first layer and a second layer;
the first layer being normally attached to the second layer;
the fastener being integrated onto a first surface of the bonded layer;
the adhesive layer being superimposed onto a second surface of the bonded layer, wherein the second surface is positioned opposite to the first surface across the bonded layer;
the protective cover being detachably attached to the second surface of the bonded layer; and
the protective cover covering the adhesive layer.

2. The versatile decorative device of claim 1, comprising:
at least one aperture;
the at least one aperture traversing through the bonded layer; and
the fastener being integrated through the at least one aperture.

3. The versatile decorative device of claim 2, wherein the at least one aperture is a rectangular slit.

4. The versatile decorative device of claim 2, wherein the at least one aperture is reinforced by a reinforcement medium.

5. The versatile decorative device of claim 2, comprising:
the at least one aperture being a plurality of pairs of slits;
a single pair of slits being positioned parallel to each other, wherein the single pair of slits is from the plurality of pairs of slits; and
the plurality of pairs of slits being distributed along a length of the bonded layer.

6. The versatile decorative device of claim 2, comprising:
the fastener being a string and the at least one aperture being a pair of slits; and
the string being threaded through the pair of slits.

7. The versatile decorative device of claim 1, wherein a first transversal cross section of the first layer is same as a second transversal cross section of the second layer.

8. The versatile decorative device of claim 1, comprising:
a decorative label; and
the decorative label being mounted onto the bonded layer.

9. The versatile decorative device of claim 1, wherein the bonded layer is a flexible fabric.

10. The versatile decorative device of claim 1, wherein terminal edges of the first layer and the second layer is interconnected.

11. The versatile decorative device of claim 1, wherein the protective cover is a peel-off paper.

12. The versatile decorative device of claim 1, comprising:
a first part of a first fastener being integrated onto a first bonded layer;
a second part of the first fastener being integrated onto a second bonded layer; and
the first bonded layer being detachably connected to the second bonded layer, wherein the first part of the first fastener is fastened with the second part of the first fastener.

13. The versatile decorative device of claim 1, wherein the bonded layer is a furniture cover.

14. A versatile decorative device, comprising:
a bonded layer;
at least one aperture;
a fastener;
the bonded layer comprising a first layer and a second layer;
the first layer being normally attached to the second layer; and
the fastener being integrated onto a first surface of the bonded layer, wherein the first surface is opposite to the second surface across the bonded layer.

15. The versatile decorative device of claim 14, wherein the at least one aperture is a rectangular slit.

16. The versatile decorative device of claim 14, comprising:
the at least one aperture being a plurality of pairs of slits;
a single pair of slits being parallel to each other, wherein the single pair is from the plurality of pairs of slits; and
the plurality of pairs of slits being distributed along the bonded layer.

17. The versatile decorative device of claim 14, wherein the bonded layer is flexible and stretchable.

18. The versatile decorative device of claim 17, wherein the bonded layer is a furniture cover.

19. The versatile decorative device of claim 14, comprising:
the second layer being attached to at least one specific region of the first layer, wherein the at least one specific region comprises regions around the at least one aperture.
